(19) United States
(12) Patent Application Publication
(10) Pub. No.: US 2005/0022938 A1
(43) Pub. Date: Feb. 3, 2005

(54) Apparatus for bonding substrates and method for bonding substrates

(75) Inventor: Hirokazu Masuda, Yokohama-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Shibaura Mechatronics Corporation, Yokohama-shi (JP)

(21) Appl. No.: 10/742,540

(22) Filed: Dec. 19, 2003

(30) Foreign Application Priority Data
Dec. 26, 2002 (JP) 2002-378179

(51) Int. Cl. B32B 31/00; B30B 1/00; B23K 37/00

(52) U.S. Cl. 156/580

(57) ABSTRACT

Includes a lower holding table on which one substrate is held with the inner surface up and the outer surface down, an upper holding table provided above and opposed to the lower holding table, the bottom surface of which is used as a holding surface that holds the other substrate, a supplying device that holds the other substrate with the outer surface up and supplies the other substrate to a position at which the outer surface of the other substrate faces the holding surface of the upper holding table, a delivering device that delivers the other substrate that has been supplied to the position opposing the holding surface of the upper holding table by the supplying device, onto the holding surface of the upper holding table such that the outer surface of the other substrate is held, and a driving device that drives the upper and lower holding tables relatively in vertical and horizontal directions to align the two substrates held on the holding tables and bond them together via a sealing agent.

### CROSS-REFERENCE TO RELATED APPLICATIONS

This application is based upon and claims the benefit of priority from prior Japanese Patent Application No. 2002-378179, filed Dec. 26, 2002, the entire contents of which are incorporated herein by reference.

### BACKGROUND OF THE INVENTION

1. Field of the Invention

The invention relates to a bonding apparatus and a bonding method for bonding two substrates together via a sealing agent with a fluid interposed between the substrates.

2. Description of the Related Art

In the process of manufacturing flat display panels typified by liquid crystal display panels, and the like, bonding work is performed, in which two substrates are opposed to each other with a predetermined space in between, liquid crystal, as a fluid, is sealed-in between the substrates, and the substrates are bonded together with a sealing agent.

In the bonding work, the sealing agent is applied such that a shape of a frame is formed with the sealing agent on the inner surface (the surface to be bonded) of one of the two substrates. A predetermined amount of the liquid crystal in drops is supplied by dropping to the part corresponding to the inside of the frame made of the sealing agent of the inner surface of the substrate, or to that of the other substrate.

Next, one of the two substrates is supplied and placed on the top surface of a lower holding table with the outer surface (the surface opposite to the surface to be bonded) down. The other substrate is attracted and held on a holding surface formed at the bottom surface of an upper holding table with the outer surface up by the means that will be described later. Then, after the two substrates are aligned by driving the lower holding table and the upper holding table relatively in horizontal directions, the two substrates are bonded together with a sealing agent by driving the lower holding table and the upper holding table also relatively in vertical directions. Such prior art is disclosed in Japanese Patent Application KOKAI Publication No. 2000-66163.

The inner surfaces, which face each other when the substrates are bonded together, are device surfaces at which circuit patterns such as electrodes are formed. Hence, at the time of supplying the substrates onto the lower holding table and the upper holding table, workers try not to touch the device surfaces to prevent the device surfaces from becoming dirty or being damaged.

However, with the recent upsizing and thinning of substrates, there has been the problem that it is difficult to improve productivity if workers are to manually supply substrates onto the lower holding table and the upper holding table. It is particularly difficult to supply a substrate without touching its inner surface onto the upper holding table whose holding surface faces downward, and hence, improvement has been desired.

Hence, there was the idea of turnably providing the upper holding table, supplying a substrate with the inner surface up onto the holding surface while the holding surface is facing up, then turning the upper holding table 180 degrees, thereby causing the inner surface of the substrate to face the inner surface of the substrate held on the lower holding table, and bonding these substrates.

However, if the upper holding table is turnably provided, space is necessary to allow the holding table to turn and consequently the apparatus will be larger. Moreover, because the turnably provided upper holding table has accordingly reduced support stiffness, the upper holding table will be displaced by the load applied at the time of bonding and necessary bonding accuracy cannot be achieved. Thus, turnably providing the upper holding table is not good.

The present invention provides an apparatus for bonding substrates and a method for bonding substrates that allow a substrate to be delivered to the holding surface of the upper holding table while the inner surface of the substrate is prevented from becoming dirty or being damaged.

### BRIEF SUMMARY OF THE INVENTION

The invention is a bonding apparatus for bonding two substrates together via a sealing agent with inner surfaces of the substrates opposing each other, wherein the sealing agent is applied such that a shape of a frame is formed with the sealing agent on the inner surface of one of the two substrates, and liquid is dropped on a part corresponding to an inside of the frame made of the sealing agent, of the inner surface of one of the two substrates, the substrate bonding apparatus characterized by comprising:
a lower holding table holding one substrate with the inner surface and an outer surface of the one substrate facing up and down, respectively;
an upper holding table provided above the lower holding table such as to oppose the lower holding table, and having a bottom surface used as a holding surface that holds the other substrate;
a supplying device configured to hold the other substrate with an outer surface of the other substrate up and to supply the other substrate to a position at which the outer surface of the other substrate opposes the holding surface of the upper holding table;
a delivering device configured to deliver the other substrate supplied to the position opposing the holding surface of the upper holding table by the supplying device, onto the holding surface of the upper holding table such that the outer surface of the other substrate is held; and
a driving device configure to drive the upper holding table and the lower holding table relatively in vertical directions and to bond the two substrates respectively held on the holing tables together via the sealing agent.

The invention is a bonding method for bonding two substrates together via a sealing agent with inner surfaces of the substrates opposing each other, wherein the sealing agent is applied such that a shape of a frame is formed with the sealing agent on the inner surface of one of the two substrates, and liquid is dropped on a part corresponding to an inside of the frame made of the sealing agent, of the inner surface of one of the two substrates, the method for bonding the substrates characterized by comprising:
supplying and placing one substrate with the inner surface and an outer surface of the one substrate facing up and down, respectively, on a lower holding table;
holding an outer surface of the other substrate with the outer surface of the other substrate facing up and supplying the other substrate to a position opposing a holding surface, which is formed to face downward, of an upper holding table;
receiving the other substrate supplied to the position opposing the holding surface of the upper holding table, by holding the outer surface of the other substrate;
delivering the substrate received by holding the outer surface, onto the holding surface of the upper holding table such that the outer surface of the substrate is held;
driving the upper holding table and the lower holding table relatively in vertical directions and bonding the two substrates respectively held on the holding tables via the sealing agent.

The invention is a bonding method for bonding two substrates together via a sealing agent with inner surfaces of the substrates opposing each other, wherein the sealing agent is applied such that a shape of a frame is formed with the sealing agent on the inner surface of one of the two substrates, and liquid is dropped on a part corresponding to an inside of the frame made of the sealing agent, of the inner surface of one of the two substrates, the method for bonding the substrates characterized by comprising:
supplying and placing one substrate with the inner surface and an outer surface of the one substrate facing up and down, respectively, on an top surface of a lower holding table;
holding an outer surface of the other substrate with the outer surface of the other substrate facing up and supplying the other substrate to a position opposing a holding surface, which is formed to face downward, of an upper holding table by a supplying device;
raising the supplying device, causing the supplying device to enter escape portions formed in the holding surface, and delivering the other substrate onto the holding surface of the upper holding table such that the outer surface of the other substrate is held; and
driving the upper holding table and the lower holding table relatively in vertical directions and bonding the two substrates respectively held on the holding tables together via the sealing agent.

According to the invention, it is made possible to deliver a substrate onto the upper holding table by holding it with the outer surface up, supplying it to a position opposing the holding surface of the upper holding table, and causing the outer surface of the substrate to be held on the holding surface. Hence, the substrate can be held on the holding surface of the upper holding table without the inner surface of the substrate being touched.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing an apparatus for assembling a liquid crystal display panel according to a first embodiment of the invention.

FIG. 2 is a section view showing the general structure of a bonding apparatus.

FIG. 3 is a plan view of an arm of a robot apparatus.

FIGS. 4A to 4D are illustrations of the steps of delivering a second substrate to a holding surface of an upper holding table.

FIG. 5 shows a second embodiment of the invention and is an illustration of the step before a second substrate is delivered to a holding surface of an upper holding table.

FIG. 6 is a section view showing the general structure of a bonding apparatus according to a third embodiment of the invention.

### DETAILED DESCRIPTION OF THE INVENTION

One embodiment of the invention will now be described with reference to the drawings.

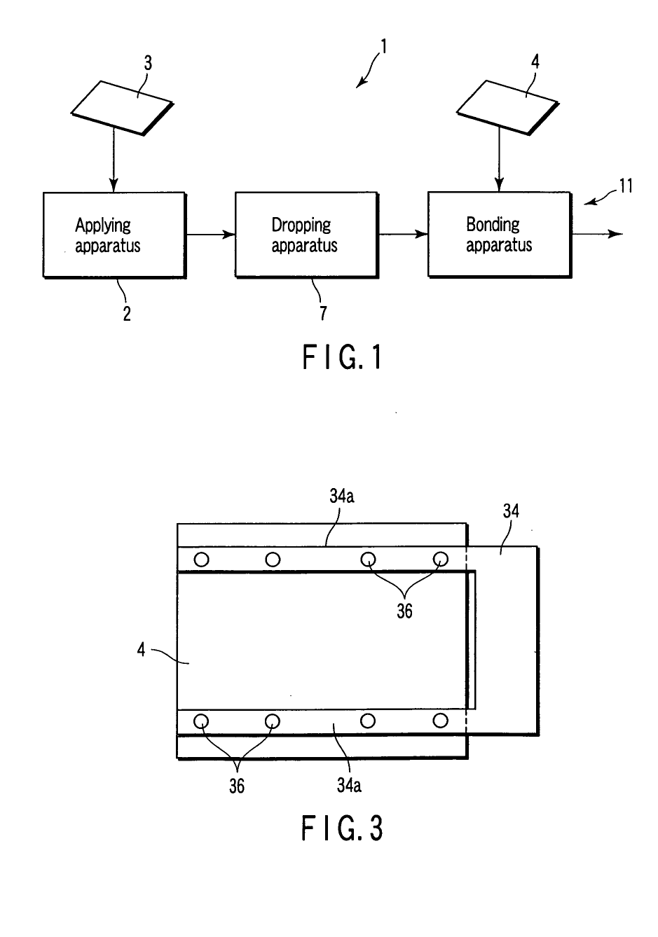

FIGS. 1 to 4D show a first embodiment of the invention. FIG. 1 is a schematic view showing an apparatus 1 for assembling a liquid crystal display panel. The assembling apparatus 1 has an apparatus 2 for applying a sealing agent. Of first and second substrates 3, 4 comprising a liquid crystal display panel, the first substrate 3 is supplied to the applying apparatus 2.

The applying apparatus 2 has a table on which the first substrate 3 is supplied and placed, and an application nozzle placed above the table (neither of which is shown). Driving the application nozzle relatively to the first substrate 3 in the X, Y, and Z directions causes a sealing agent (not shown) made of viscoelastic material to be applied on the inner surface (the surface to be bonded) of the first substrate 3 such that a shape of a rectangular frame is formed with the sealing agent.

The first substrate 3 on which the sealing agent has been applied is supplied to a dropping apparatus 7. The dropping apparatus 7 has a table on which the first substrate 3 is placed, and a dropping nozzle placed above the table (neither of which is shown). The dropping nozzle is driven relatively to the first substrate 3 in the X, Y, and Z directions. In doing so, drops of liquid crystal, as a liquid, are supplied by dropping on the inner surface of the first substrate 3 within the area surrounded by the sealing agent so as to form a predetermined pattern, for example, a matrix, with the liquid crystal drops.

The first substrate 3 on which the liquid crystal has been dropped is supplied to a bonding apparatus 11, and then the second substrate 4 is supplied to the bonding apparatus 11. Then, the first substrate 3 and the second substrate 4 are positioned and are bonded together, as will be described later. Thus, the pair of substrates 3, 4 are bonded together with the sealing agent, and the liquid crystal is sealed between the substrates 3, 4.

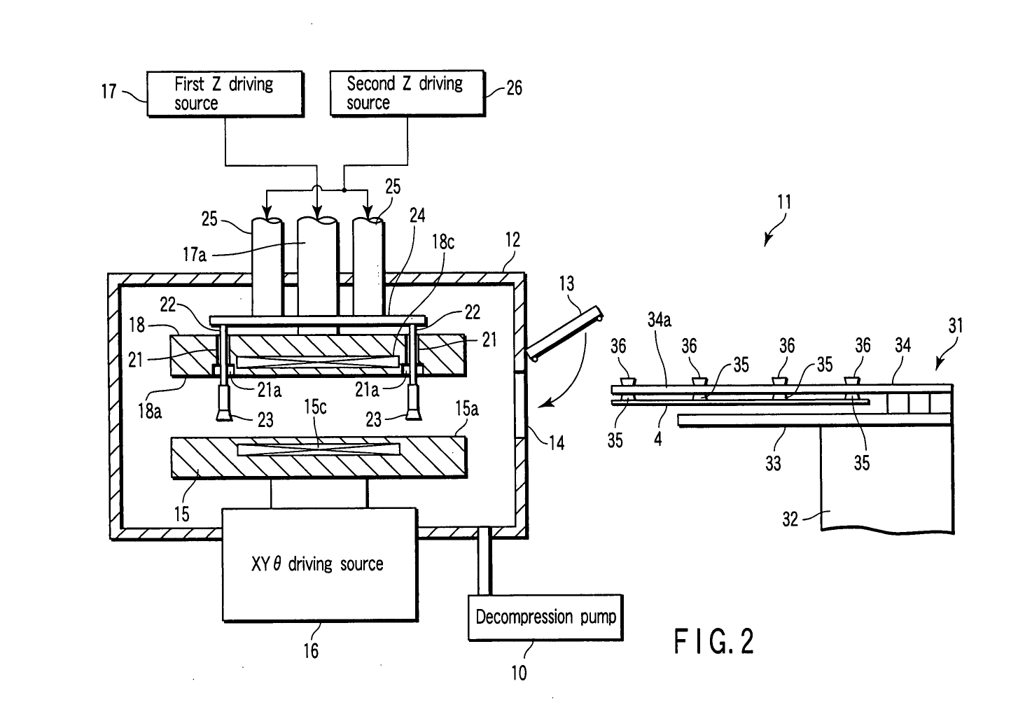

The bonding apparatus 11 has a chamber 12, as shown in FIG. 2. The pressure inside the chamber 12 is reduced to a predetermined pressure, for example, approximately 1 Pa, by a decompression pump 10. A removal/supply opening 14, which is opened and closed with a shutter 13, is formed on one side of the chamber 12. The first substrate 3 and the second substrate 4 are supplied and removed through the removal/supply opening 14 by a robot apparatus 31 serving as supplying means, which will be described later.

A lower holding table 15 is provided in the chamber 12. The lower holding table 15 is driven by a XYθ driving source 16 in the X, Y, and θ directions. The first substrate 3, on which the sealing agent has been applied by the applying apparatus 2 and the liquid crystal has been dropped by the dropping apparatus 7, is supplied by the robot apparatus 31 on a holding surface 15a (the top surface) of the lower holding table 15 with the inner surface, on which the liquid crystal has been dropped, facing up, as will be described later. The outer surface (the surface opposite to the surface to be bonded) of the substrate 3 supplied onto the holding surface 15a is held on the holding surface 15a with predetermined holding power, for example, electrostatic force.

Note that a delivery pin, not shown in the drawings, for receiving the first substrate 3, which is supplied by an arm 34 of the robot apparatus 31 onto the holding surface 15a, from the arm 34 is provided to the lower holding table 15 so as to be capable of protruding from and sinking into the holding surface 15a.

An upper holding table 18, driven by a first Z driving source 17 via a first drive shaft 17a in vertical directions (Z direction), is placed above the lower holding table 15. That is, the upper holding table 18 is driven in directions in which the upper holding table 18 moves closer to or away from the lower holding table 15. The bottom surface of the upper holding table 18 is formed at a holding surface 18a. The outer surface of the second substrate 4 is held on the holding surface 18a by electrostatic force, as will be described later.

Electrodes 15c, 18c, each of which comprising an electrostatic chuck, are buried in the holding tables 15, 18, respectively. When the electrodes 15c, 18c are supplied with power by a power source not shown in the drawings, electrostatic force that holds the substrates 3, 4 is generated in each of the holding tables 15, 18.

Note that instead of being provided with an electrostatic chuck, the lower holding table 15 may be provided with an elastic sheet having a predetermined frictional resistance on the holding surface 15a such that the first substrate 3 is supplied and placed on the elastic sheet.

A plurality of, for example, four, through-holes 21 (only two are shown in the drawings) are bored through the upper holding table 18 in the thickness direction. In each of the through holes 21, a rod-like movable member 22 is inserted so as to be movable in vertical directions. The top ends of the movable members 22 are coupled together by a rectangular coupling member 24. At each of the bottom ends, a vacuum pad 23 communicating with a suction pump not shown in the drawings is provided via a spring not shown in the drawings so as to be elastically deformable in vertical directions. The bottom end portion of each through-hole 21 is formed into a large-diameter portion 21a into which the vacuum pad 23 enters.

The bottom ends of a pair of second drive shafts 25 are coupled to the top surface of the coupling member 24. The vacuum pads 23 are driven in the Z direction by a second Z driving source 26 via the second drive shafts 25. The movable member 22, the vacuum pads 23, the coupling member 24, the second drive shafts 25, and the second Z driving source 26 make up the delivery means of the invention.

The first and second drive shafts 17a, 25 pierce through the top wall of the chamber 12, and the piercing-parts of the first and second drive shafts 17a, 25 are made movable in vertical directions by bellows or the like not shown in the drawings in a state in which airtightness is achieved with respect to the top wall.

As shown in FIG. 2, the robot apparatus 31 has a base 32 that can be driven in the X, Y, and Z directions. The base portion 32 is provided with a guide plate 33. The guide plate 33 is provided with an arm 34 such that the arm 34 can be driven to move forward and backward along the guide plate 33 by a driving source such as a cylinder, which is not shown in the drawings.

As shown in FIG. 3, the arm 34 has a pair of arm portions 34a and is formed such that its planar shape is roughly the shape of the character “ [symbol] .” As shown in FIG. 2, a plurality of lower suction pads 35 are provided at the bottom surfaces of the pair of arm portions 34a of the arm 34, and a plurality of upper suction pads 36 are provided at the top surfaces. The lower suction pads 35 and the upper suction pads 36 are communicated with a vacuum pump through separate suction paths. Hence, the arm 34 can suck and hold substrates on the top and bottom surfaces.

As shown in FIG. 2, the robot apparatus 31 having the above-described structure is placed so as to face the removal/supply opening 14 formed on one side of the chamber 12. Hence, the arm 34 can enter the chamber 12 through the removal/supply opening 14.

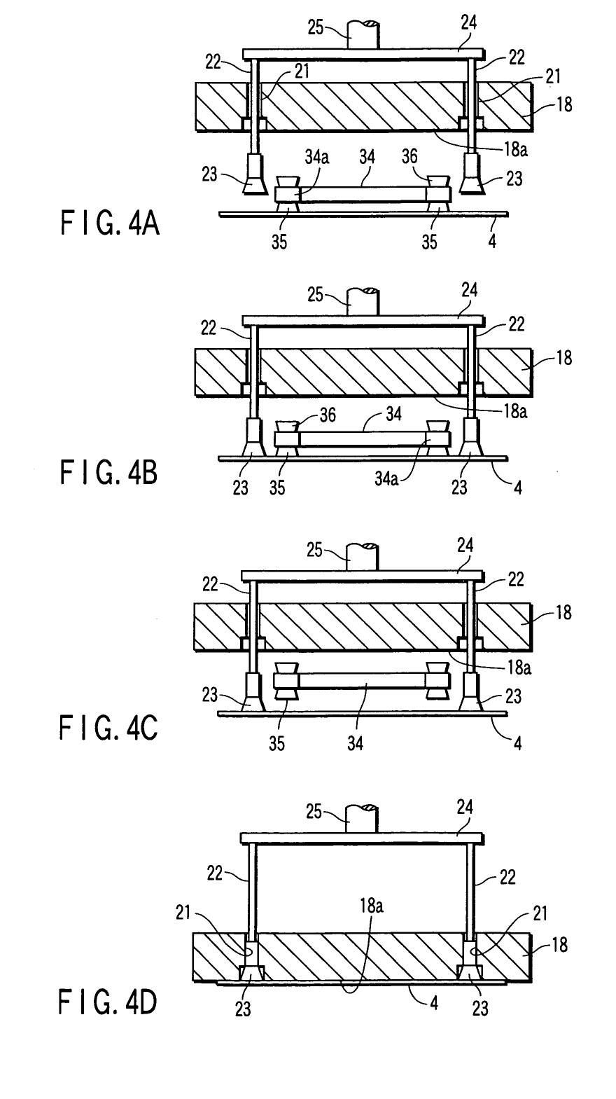

Next, the procedure for bonding the first substrate 3 and the second substrate 4 together using the bonding apparatus 11 having the above-described structure will be described with reference to FIGS. 4A to 4D.

First, the second substrate 4 is supplied with the inner surface down on the bottom surface of the arm 34 of the robot apparatus 31 by another robot apparatus and the like not shown in the drawings. Hence, as shown in FIG. 4A or 2, the outer surface of the second substrate 4, which is facing up, is sucked and held on the lower suction pads 35 at the bottom surface of the arm 34.

The arm 34, sucking and holding the second substrate 4, enters the chamber 12 through the removal/supply opening 14, and is positioned so that the top surface of the second substrate 4 faces the holding surface 18a of the upper holding table 18.

When the second substrate 4 is positioned at a position at which the second substrate 4 faces the holding surface 18a of the upper holding table 18, the arm 34 of the robot apparatus 31 is driven in an upward direction, as shown in FIG. 4B. Hence, the outer surface of the second substrate 4, which is facing up, comes into contact with the vacuum pads 23 provided at the bottom ends of the movable members 22, and consequently, the outer surface of the second substrate 4 is held by the sucking force generated at the vacuum pads 23. Note that at that time, the vacuum pads 23 suck parts of the outer surface of the second substrate 4 outside the arm portions 34a of the arm 34, and therefore, the vacuum pads 23 do not interfere with the arm 34.

After the vacuum pads 23 suck and hold the outer surface of the second substrate 4, the sucking force of the lower suction pads 35 of the arm 34 is shut off, and the arm 34 is moved upward as shown in FIG. 4C and then backward, thereby exiting from the inside of the chamber 12.

Next, the movable members 22 are driven in an upward direction by the second Z driving source 26. Consequently, the vacuum pads 23 enter the through-holes 21 as shown in FIG. 4D, and the outer surface of the second substrate 4 comes into contact with the holding surface 18a of the upper holding table 18. Hence, the second substrate 4 is attracted and held by the electrostatic force generated at the holding surface 18a.

After the second substrate 4 is attracted and held by electrostatic force on the holding surface 18a, the sucking force of the vacuum pads 23 is removed. Note that it is only necessary to remove the sucking force of the vacuum pads 23 before the second substrate 4 is removed from the attraction surface 18a of the upper holding table 18.

In other words, the second substrate 4 can be attracted and held on the holding surface 18a of the upper holding table 18 without the arm 34 of the robot apparatus 31 touching the inner surface, which is a device surface.

Next, the first substrate 3 delivered from the dropping apparatus 7 is supplied with the inner surface up on the top surface of the arm 34 of the robot apparatus 31 where the upper suction pads 36 are provided. The first substrate 3 supplied on the top surface of the arm 34 is sucked and held on the upper suction pads 36. In this state, the removal/supply opening 14 of the chamber 12 is opened, and the arm 34 enters the chamber 12 to a position above the holding surface 15a of the lower holding table 15 and is moved downward to a predetermined position. At that time, the sucking force of the lower suction pads 35 acting on the first substrate 3 is removed.

Next, the delivery pin, which is not shown in the drawings but is provided to the lower holding table 15, is moved upward and picks up and receives the first substrate 3 from the arm 34. In that state, the arm 34 moves backward from the inside of the chamber 12. After the arm 34 moves backward, the delivery pin moves downward, and the first substrate 3 is attracted and held by electrostatic force, with the inner surface facing up and the outer surface facing down, on the holding surface 15a of the lower holding table 15.

Supplying the second substrate 4 onto the upper holding table 18, and then, the first substrate 3 onto the lower holding table 15 in the above-described manner brings about the following advantages. That is, when the first substrate 3 is supplied onto the lower holding table 15, the second substrate 4 is already attracted and held on the upper holding table 18.

Hence, the delivery of the second substrate 4 is not performed above the first substrate 3 after the first substrate 3 is attracted and held on the lower holding table 15, the dust produced at the time of delivery does not stick to the inner surface of the first substrate 3 held on the lower holding table 15.

Dust sticking to the inner surface of the first substrate 3 is a cause of reduction of the display quality of the liquid crystal display panel to be manufactured. However, dust is prevented from sticking to the inner surface of the first substrate 3 by following the above-described work procedure, and consequently, the display quality of the liquid crystal display panel can be improved.

After causing the first substrate 3 and the second substrate 4 to be attracted and held on the holding surfaces 15a, 18a of the holding tables 15, 18, respectively, the removal/supply opening 14 is closed with the shutter 13, the decompression pump 10 is activated, and the pressure inside the chamber 12 is reduced to a predetermined pressure.

Subsequently, the lower holding table 15 is driven in a horizontal direction by the XYθ driving source 16 and aligns the first substrate 3 with the second substrate 4. After that, the upper holding table 18 is driven in a downward direction by the first Z driving source 17. Hence, the first substrate 3 and the second substrate 4 which have been aligned are bonded together with the sealing agent.

After the first substrate 3 and the second substrate 4 are bonded together, gas is supplied into the chamber 12 and the pressure inside is gradually brought back to atmospheric pressure. Hence, pressure is applied to the pair of substrates 3, 4 owing to the pressure difference between the pressure inside the chamber 12 and the pressure between the pair of substrates 3, 4 bonded together, and the pair of substrates 3, 4 can be securely bonded together with the sealing agent.

Next, the electrostatic force of the upper holding table 18 is removed, and the table 18 is moved upward. Next, the electrostatic force of the lower holding table 15 is removed, the delivery pin is moved upward, and the bonded substrates 3, 4 are moved upward above the lower holding table 15. After that, the arm 34 of the robot apparatus 31 enters on the bottom surface side of the first substrate 3 and the delivery pin is descended, thereby delivering the substrates 3, 4 to the arm 34. In that state, the arm 34 is moved backward and the substrates 3, 4 are carried out of the chamber 12.

Hence, the second substrate 4 is supplied to the holding surface 18a of the upper holding table 18 and is attracted and held without the inner surface of the second substrate 4 touching the arm 34 of the robot apparatus 31. For this reason, the inner surface of the second substrate 4 can be prevented from becoming dirty or damaged at the time of bonding the first substrate 3 and the second substrate 4 together. Consequently, the quality of liquid crystal display panels manufactured by bonding first and second substrates 3, 4 together can be improved, and the yield can be improved.

Because the robot apparatus 31 that holds the second substrate 4 with the outer surface up, and the vacuum pads 23 that suck and hold the outer surface of the second substrate 4 held by the robot apparatus 31 and deliver the second substrate 4 onto the holding surface 18a of the upper holding table 18, the second substrate 4 can be supplied in the state in which the inner surface of the second substrate 4 is flipped over so as to face down.

Hence, it is only necessary to provide the upper holding table 18 so as to be capable of being driven in vertical directions; it is unnecessary to provide such a turning mechanism as the one that has been described as prior art, and the reduction of the support stiffness of the upper holding table 18 can be prevented that much. Hence, the deformation of the upper holding table 18 can be prevented when pressure is applied to the first and second substrates 3, 4 to bond them together, and consequently, bonding accuracy can be improved.

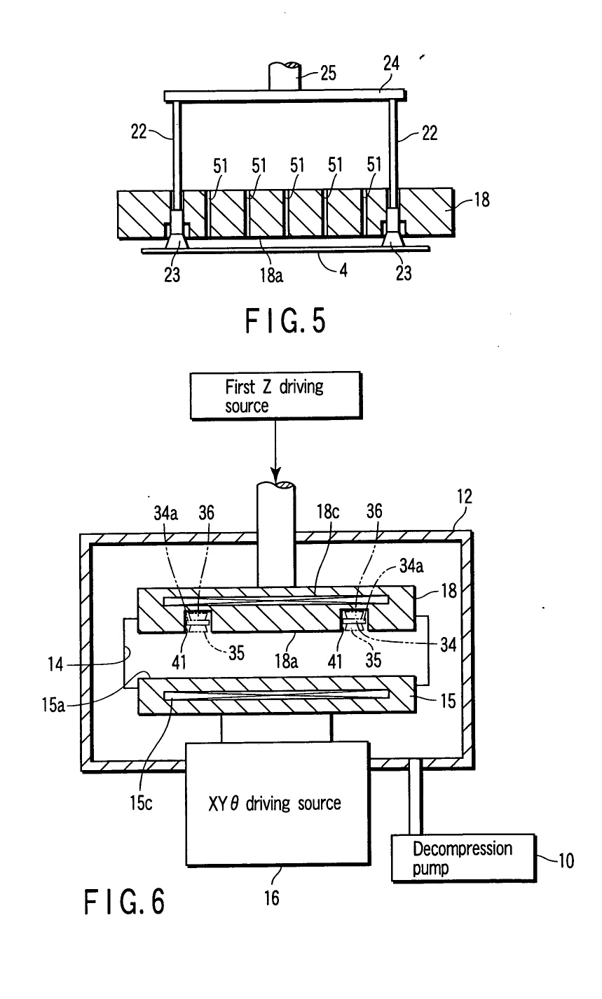

FIG. 5 is a second embodiment showing a modification of the first embodiment, where the second substrate 4 is attracted and held on the holding surface 18a of the upper holding table 18. That is, after the second substrate 4 sucked on the lower suction pads 35 of the arm 34 as shown in FIG. 4C is sucked on the vacuum pads 23 at atmospheric pressure, the arm 34 is moved out of the chamber 12. After that, the second substrate 4 is moved upward and the upward movement is stopped before the outer surface comes into contact with the holding surface 18a of the upper holding table 18, as shown in FIG. 5. In other words, the second substrate 4 is caused to stand by in the state in which a predetermined space is kept between the outer surface of the second substrate 4 and the holding surface 18a.

In that state, the removal/supply opening 14 is closed with the shutter 13 and the pressure inside the chamber 12 is reduced. When the pressure inside the chamber 12 is reduced to a predetermined pressure P that is higher than the pressure at which the two substrates 3, 4 are bonded together, the second substrate 4 is delivered onto the holding surface 18a of the upper holding table 18 as shown in FIG. 4D. In other words, the pressure inside the chamber 12 at which the two substrates 3, 4 are bonded together is, for example, approximately 1 Pa, and if that pressure is denoted by Pb, Pb<P.

Providing the process shown in FIG. 5 between the processes shown in FIGS. 4C and 4D, as described above, permits the second substrate 4 to be surely prevented from falling off from the holding surface 18a of the upper holding table 18 for the reason stated below even when the pressure inside the chamber 12 is rapidly reduced.

That is, when the second substrate 4 is held on the holding surface 18a of the upper holding table 18 at atmospheric pressure, if, for example, the second substrate 4 has undulations, minute gaps are created between the substrate 4 and the holding surface 18a, air is trapped in the gaps, and layers of air are formed.

If reduction of the pressure inside the chamber 12 is started in such a state, a pressure difference is created between the layers of air and the atmosphere in the chamber 12 as the pressure reduction continues. That is, the pressure on the outer surface side of the second substrate 4 held on the holding surface 18a becomes higher than the pressure on the inner surface side, which is not held. For this reason, force acts on the second substrate 4 in a direction moving away from the holding surface 18a.

If the pressure inside the chamber 12 is reduced over a sufficiently long time, the air between the outer surface of the second substrate 4 and the holding surface 18a will be gradually removed in the process of pressure reduction. Hence, an increase in pressure difference between the outer surface and the inner surface of the substrate 4 will be prevented, and the substrate 4 can be held on the holding surface 18a relatively well.

However, if it is necessary to reduce the pressure inside the chamber 12 to the bonding pressure Pb in a short time for production reasons, such as reduction of cycle time, reduction of the pressure inside the chamber 12 progresses before the air between the second substrate 4 and the holding surface 18a is sufficiently removed, the pressure difference between the outer surface and the inner surface of the second substrate 4 increases, and consequently, the force pulling the second substrate 4 away from the holding surface 18a increases. When this force becomes greater than the electrostatic force holding the second substrate 4 on the holding surface 18a, the substrate 4 sometimes falls off from the holding surface 18a.

Providing the process shown in FIG. 5 between the processes shown in FIGS. 4C and 4D, thereby preventing the second substrate 4 from coming into contact with the holding surface 18a until the pressure inside the chamber 12 is reduced to the above-described pressure P and holding the second substrate 4 with a predetermined space between it and the holding surface 18a, makes the discharge of the air between the second substrate 4 and the holding surface 18a easier even in the case where the pressure inside the chamber is reduced to the predetermined pressure Pb in a short time. Therefore, if the second substrate 4 is attracted and held on the holding surface 18a after the process shown in FIG. 5, the force pulling the substrate 4 away from the holding surface 18a can be suppressed, and consequently, the substrate 4 can be prevented from falling off.

That is, if the rotation speed of the driving motor of the decompression pump 10 that evacuates the chamber 12 is constant, the decrease rate of the pressure inside the chamber 12 per unit time is reduced in a quadratic curve as the pressure inside the chamber 12 decreases. In other words, when the pressure inside the chamber 12 is close to atmospheric pressure, the rate of pressure decrease per unit time is high, but the closer it is to vacuum, the lower the rate of pressure decrease per unit time becomes.

Therefore, even though reduction of the pressure inside the chamber 12 in a short time leaves air between the second substrate 4 and the holding surface 18a, the pressure difference between the outer surface and the inner surface of the second substrate 4 created by the layers of air can be made sufficiently less if the second substrate 4 is held on the holding surface 18a after the pressure inside the chamber 12 is reduced to the pressure P, rather than if the second substrate 4 is held on the holding surface 18a at atmospheric pressure. Therefore, even in the case where the pressure inside the chamber 12 is reduced in a short time, the substrate 4 can be prevented even more surely from falling off.

The pressure P inside the chamber when the second substrate 4 is delivered onto the holding surface 18a of the upper holding table 18 will now be described. The vacuum pads 23 vacuum-suck the second substrate 4. Hence, when the pressure inside the chamber 12 reaches the vacuum pressure for vacuum-sucking the substrate 4 by the vacuum pads 23, i.e., the pressure of the vacuum suction of the suction pump, there will be no pressure difference between the two and the vacuum-sucking force of the vacuum pads 23 on the substrate 4 will no longer be produced. As a result, the second substrate 4 will fall off from the vacuum pads 23.

Therefore, it is necessary to deliver the substrate 4 onto the holding surface 18a at the time at which the substrate 4 does not fall off from the vacuum pads 23 and the pressure inside the chamber 12 is sufficiently reduced. The pressure inside the chamber 12 at that time is the above-described pressure P. The optimum value of the pressure P can be obtained by conducting experiments.

Whether the pressure inside the chamber 12 has reached the pressure P can be made known by providing a pressure sensor inside the chamber 12 and from the detected value. Therefore, it is only necessary to deliver the second substrate 4 onto the holding surface 18a at the time when the detected value of the pressure sensor is the pressure P. It is only necessary to apply a voltage to the electrode 18c in accordance with the timing of delivery and to produce electrostatic force at the upper holding table 18.

As stated above, it is more difficult for the second substrate 4 to fall off from the holding surface 18a when it is held on the holding surface 18a at atmospheric pressure than when it is held after the pressure inside the chamber 12 is reduced. Hence, if it is between the time the pressure inside the chamber 12 begins to decrease and the time it reaches the pressure P, even if the substrate 4 is delivered onto and held on the holding surface 18a, it can be held in a state in which it is more difficult for the substrate to fall off than when it is held at atmospheric pressure.

As shown in FIG. 5, a plurality of through-holes 51 may be provided in the upper holding table 18. The through-holes 51 are opened in the holding surface 18a at one end, and into the chamber 12 at the other end. In the embodiment, the through holes 51 are opened in the top surface of the holding table 18 at the other end.

If a plurality of through-holes 51 are provided in the holding table 18 as described above, the air in the gaps between the substrate 4 and the holding surface 18a is easily discharged through the through-holes 51 when the pressure inside the chamber 12 is reduced. Hence, the substrate 4 held on the holding surface 18a can be prevented even more surely from falling off.

Even in the case where the second substrate 4 is held on the holding surface 18a at atmospheric pressure, the air remaining between the holding surface 18a and the substrate 4 held on the holding surface 18a is discharged as the pressure inside the chamber 12 is reduced. Hence, there is the advantage that the substrate 4 is prevented from falling off from the holding surface 18a.

That is, it is more difficult for the substrate 4 to fall off from the holding surface 18a if through-holes 51 are provided in the upper holding table than if no through-holes are provided when the second substrate 18a is held on the holding surface 18a at atmospheric pressure or when the pressure inside the chamber 12 is reduced in a short time.

FIG. 5 describes the case where the upward movement of the vacuum pads 23 is stopped partway, but, for example, the second substrate 4 may be caused to stand by until the pressure inside the chamber 12 is reduced to the pressure P in the state shown in FIG. 4C.

Note that if upward movement of the vacuum pads 23 is stopped partway as shown in FIG. 5, there are advantages, such as the time until the substrate 4 is delivered onto the holding surface 18a after the pressure inside the chamber 12 is reduced to the pressure P can be shortened, and the second substrate 4 held on the vacuum pads 23 does not get in the way when the first substrate 3 is supplied onto the lower holding table 15.

FIG. 6 shows a third embodiment of the invention. Note that the parts that are the same as those of the first embodiment will be designed by the same symbols and descriptions thereof will be omitted. In other words, the embodiment is a modification of the delivery means, which delivers the second substrate 4, whose outer surface is sucked and held on the bottom surface of the arm 34 of the robot apparatus 31, onto the holding surface 18a of the upper holding table 18. The delivery means of the embodiment has a pair of escape portions 41 formed to open in the holding surface 18a of the upper holding table 18. The arm portions 34a, which are provided with the suction pads 35, 36, of the arm 34 move into the pair of escape portions 41. Moreover, the pair of escape portions 41 has a depth dimension that allows the suction pads 35 to move away from the second substrate 4.

Hence, when the arm 34 whose lower suction pads 35 have sucked the outer surface of the second substrate 4 thereon is positioned at a position opposing the holding surface 18a and is driven in an upward direction to cause the outer surface of the second substrate 4 to be attracted onto the attraction surface 18a, the arm portions 34a, which are provided with the suction pads 35, 36, of the arm 34 move into the escape portions 41.

Therefore, the outer surface of the second substrate 4 sucked and held on the lower suction pads 35 can be brought into contact with the holding surface 18a and is thus attracted and held by electrostatic force on the holding surface 18a. After that, the arm 34 moves backward, leaves the escape portions 41, and exists from the chamber 12.

That is, the formation of escape portions 41, into which the arm 34 can enter, in the upper holding table 18 permits delivery of the second substrate 4, whose outer surface is sucked and held on the arm 34, onto the holding surface 18a of the upper holding table 18.

The invention is not limited to the above-described embodiments and can be variously modified. For example, the lower holding table is driven in the X, Y, and θ directions and the upper holding table is driven in the Z direction; however, the upper holding table may be driven in the X, Y, and θ directions and the lower holding table may be driven in the Z direction. The sealing agent and the liquid crystal are supplied on the first substrate; however, they may be supplied on the second substrate or, alternatively, the liquid crystal may be supplied on one of the substrates and the sealing agent may be supplied on the other one of the substrates, and the invention is not limited in any way in this respect.

The driving member is provided with vacuum pads to deliver the second substrate from the arm of the robot apparatus onto the holding surface of the upper holding table; however, electrostatic pads, which attract a substrate using electrostatic force, or adhesive pads, which hold a substrate with adhesive force, may be substituted for the vacuum pads.

If electrostatic pads or vacuum pads are used as described above, the substrate can be held even at the bonding pressure Pb. Hence, the process of delivering the second substrate onto the holding surface of the upper holding table in the second embodiment can be carried out at a pressure between the predetermined pressure P and the bonding pressure Pb, and there is the advantage that the substrate held on the holding surface can be prevented from falling off even better.

As regards supply of substrates into the chamber, the second substrate may be supplied onto the upper holding table after the first substrate is supplied, and the order is not limited. Furthermore, the robot apparatus may be configured to be movable between the position at which the dropping apparatus or the storage magazine of the second substrate supply the first and second substrates, and the removal/supply opening of the chamber.

Further, when the second substrate is supplied onto the upper holding table, the outer surface of the substrate is sucked and held on the lower suction pads provided to the arm of the robot apparatus; however, supporting pins may be provided on the top surface of the arm and the inner surface of the second substrate may be supported by the supporting pins while the second substrate is being supplied onto the upper holding table. This case is desirable in the respect that the supporting pins supporting the non-device area of the inner surface of the second substrate prevents the device surface from becoming dirty or damaged. Note that it is also possible to support the outer surface of the first substrate by the supporting pins and supply the first substrate to the lower holding table.

Furthermore, in the first embodiment, the vacuum pads are configured to enter the through-holes formed in the upper holding table; however, it is only necessary for the surfaces of the vacuum pads that suck the second substrate thereon to move to positions that coincide with the holding surface of the upper holding table or to positions at which the surfaces of the vacuum pads sink into the holding surface.

In the case where the vacuum pads are configured such that the surfaces that suck the second substrate thereon are moved to positions at which they sink into the holding surface of the upper holding table, after the vacuum pads suck the second substrate thereon, move upward, and deliver the second substrate onto the holding surface of the upper holding table, the vacuum pads enter the through-holes, by which the second substrate is surely separated from the vacuum pads. Such a configuration is particularly effective when adhesive pads are used instead of vacuum pads.

Further, it is good to provide an open/close valve between the vacuum pads and the suction pump, and to close the open/close valve before the pressure of the atmosphere inside the chamber becomes lower than the pressure of the vacuum suction by the suction pump after reduction of the pressure inside the chamber is started to remove the vacuum-sucking by the vacuum pads.

That is, if the vacuum-sucking force is acted on the vacuum pads until the pressure inside the chamber is reduced to the predetermined pressure, the gas in the pipes communication with the vacuum pads and the suction pump flows out into the space between the holding surface of the upper holding table and the second substrate electrostatically held on the holding surface when the pressure of the atmosphere inside the chamber becomes lower than the pressure of the vacuum-sucking by the suction pumps. There is a possibility of occurrence of the problems that the substrate electrostatically held on the holding surface is pushed away from the holding surface and is displaced on the upper holding table or caused to fall off, as a result of this outflow of gas.

However, if the open/close valve is closed before the pressure of the atmosphere inside the chamber becomes lower than the pressure of the vacuum-sucking of the suction pump as described above, the above-stated problems can be prevented. The effect becomes greater if the open/close valve is positioned as closer to the vacuum pads as possible and the pipe length between the open/close valve and the vacuum pads is made as shorter.

Furthermore, the sealing agent is not limited to the one that has both the sealing property and adhesiveness; a sealing agent that has only the sealing property may be used singly or with an adhesive agent different from the sealing agent to bond the two substrates.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A bonding apparatus for bonding two substrates together via a sealing agent with inner surfaces of the substrates opposing each other, wherein the sealing agent is applied such that a shape of a frame is formed with the sealing agent on the inner surface of one of the two substrates, and liquid is dropped on a part corresponding to an inside of the frame made of the sealing agent, of the inner surface of one of the two substrates, the bonding apparatus comprising:
a lower holding table holding one substrate with the inner surface and an outer surface of the one substrate facing up and down, respectively;
an upper holding table provided above the lower holding table such as to oppose the lower holding table, and having a bottom surface used as a holding surface that holds the other substrate;
a supplying device configured to hold the other substrate with an outer surface of the other substrate facing up and to supply the other substrate to a position at which the outer surface of the other substrate opposes the holding surface of the upper holding table;
a delivering device configured to deliver the other substrate supplied to the position opposing the holding surface of the upper holding table by the supplying device, onto the holding surface of the upper holding table such that the outer surface of the other substrate is held; and
a driving device configured to drive the upper holding table and the lower holding table relatively in vertical directions and bonding the substrates respectively held on the holing tables together via the sealing agent.

2. An apparatus for bonding substrates according to claim 1, wherein
the supplying device has holding portions that hold the outer surface of the other substrate, and
the delivering device has movable members provided so as to be movable along vertical directions of the upper holding table, and holding portions that are provided at bottom ends of the movable members and hold the outer surface of the substrate supplied to the position opposing the holding surface of the upper holding table by the supplying device.

3. An apparatus for bonding substrates according to claim 2, wherein
the lower holding table, the upper holding table, and the delivering device are placed in a chamber where pressure is reducible, and
the holding portions of the delivering device deliver the substrate onto the upper holding table before the pressure inside the chamber reaches a predetermined pressure after start of pressure reduction.

4. An apparatus for bonding substrates according to claim 2, wherein the movable members are provided to pierce through the upper holding table, and the holding portions of the delivering means move upward to positions at which the holding portions sink into the holding surface of the upper holding table by upward movement of the movable members.

5. An apparatus for bonding substrates according to claim 1, wherein
the supplying device has an arm extending in horizontal directions, and holding portions that are provided to the arm and hold the outer surface of the other substrate, and
the delivering device is escape portions formed to open in the holding surface of the upper holding table to prevent the arm from coming into contact with the holding surface when the substrate is moved upward to be held on the holding surface after being supplied to the position opposing the holding surface of the upper holding table by the arm.

6. An apparatus for bonding substrates according to claim 5, wherein the escape portions have a depth that permits the arm to enter to a position that causes the holding portions of the supplying device to sink into the holding surface of the upper holding table.

7. A bonding method for bonding two substrates together via a sealing agent with inner surfaces of the substrates opposing each other, wherein the sealing agent is applied such that a shape of a frame is formed with the sealing agent on the inner surface of one of the two substrates, and liquid is dropped on a part corresponding to an inside of the frame made of the sealing agent, of the inner surface of one of the two substrates, the bonding method comprising:
supplying and placing one substrate with the inner surface and an outer surface of the one substrate facing up and down, respectively, on an top surface of a lower holding table;
holding an outer surface of the other substrate with the outer surface of the other substrate facing up and supplying the other substrate to a position opposing a holding surface, which is formed to face downward, of an upper holding table;
receiving the other substrate supplied to the position opposing the holding surface of the upper holding table, by holding the outer surface of the other substrate;
delivering the substrate received by holding the outer surface, onto the holding surface of the upper holding table such that the outer surface of the substrate is held; and
driving the upper holding table and the lower holding table relatively in vertical directions and bonding the two substrates respectively held on the holding tables together via the sealing agent.

8. A method for bonding substrates according to claim 7, characterized in that
vacuum-sucking is carried out when the outer surface of the other substrate supplied to the position opposing the holding surface of the upper holding table is held and received,
bonding of the two substrates held on the holding tables is carried out in a decompressed atmosphere, and
delivery of the other substrate by causing the outer surface of the other substrate supplied to the position opposing the holding surface of the upper holding table to be held on the holding surface is performed before a pressure of the atmosphere reaches a predetermined pressure.

9. A method for bonding substrates according to claim 8, wherein the predetermined pressure corresponds to a vacuum pressure that vacuum-sucks the outer surface of the other substrate.

10. A bonding method for bonding two substrates together via a sealing agent with inner surfaces of the substrates opposing each other, wherein the sealing agent is applied such that a shape of a frame is created with the sealing agent on the inner surface of one of the two substrates, and liquid is dropped on a part corresponding to an inside of the frame made of the sealing agent, of the inner surface of one of the two substrates, the bonding method comprising:
supplying and placing one substrate with the inner surface and an outer surface of the one substrate facing up and down, respectively, on an top surface of a lower holding table;
holding an outer surface of the other substrate with the outer surface of the other substrate facing up and supplying the other substrate to a position opposing a holding surface, which is formed to face downward, of an upper holding table by a supplying device;
raising the supplying device, causing the supplying device to enter escape portions formed in the holding surface, and delivering the other substrate onto the holding surface of the upper holding table such that the outer surface of the other substrate is held; and
driving the upper holding table and the lower holding table relatively in vertical directions and bonding the two substrate held on the holding tables together via the sealing agent.
